(19) United States
(12) Patent Application Publication
(10) Pub. No.: US 2003/0160993 A1
(43) Pub. Date: Aug. 28, 2003

(54) METHOD FOR PRINTING TO A NETWORKED PRINTER

(76) Inventor: KIAN HOE KANG, SINGAPORE (SG)

Correspondence Address: HEWLETT-PACKARD COMPANY, Intellectual Property Administration, P.O Box 272400, Fort Collins, CO, 80527-2400, US

(21) Appl. No.: 09/238,235

(22) Filed: Jan. 27, 1999

(30) Foreign Application Priority Data
Oct. 30, 1998 (SG) 9803847-4

(51) Int. Cl. G06F 15/00; G06F 3/12; G06F 13/00

(52) U.S. Cl. 358/1.15; 709/203

(57) ABSTRACT

A method for printing on a printer which is connected to the same network as the workstation and which is not installed on the workstation is disclosed. If printing is restricted to only printers installed on a workstation when there are other printers on a network, a full printing capacity of the network is not fully capitalized. The invention is implemented as an application which runs on a workstation on a network running Novell Netware. The workstation is able to detect a printer which is connected to the network and which is not installed on the workstation. The workstation detects the printer by querying a server for print queue information. From the print queue information, the workstation is able to detect any printer which is not installed on the workstation. After detecting the printer, the printer is made accessible for printing on the workstation by availing a print queue corresponding to the detected printer.

### FIELD OF INVENTION

This invention relates to a method for printing to a networked printer and more particularly for printing to a networked printer from a workstation on which the networked printer has not been installed. This invention also relates to a method of redirecting a print job.

### BACKGROUND

Many businesses today use computers and devices which are connected to form a network. Connecting the computers and devices in a network allows communication between the computers and allows sharing of resources, such as devices like hard disks and printers.

On some networks, a printer has to be installed on or connected to a computer before a user of the computer can print to the printer. An installation or connection process registers on the computer a port number or a network address which is assigned to the printer. This registration of port number or address lets the computer know where to send a print job when printing to the printer. For the purpose of this specification, the term install is taken to mean both the installation and connection of a printer. More specifically, the term install when used to describe a printer is taken to mean that the printer can be printed to directly from a computer. In other words, a user on the computer will be able to send a print job directly to an installed printer by selecting the installed printer.

A printer installation process involves two major steps. The first step of which is to let the computer know where the printer is connected. If the printer is connected to the computer itself, the printer is given a port number through which the computer can send a print job to the printer. If the printer is not connected to the computer but to the network, a network address of the printer is made known to the computer. The computer prints to the printer by sending print jobs to the particular network address. The second step in the installation process involves loading a driver software which is specific to the printer on the computer, if the driver software is not already loaded. The computer communicates with the printer through this driver software. The driver software also translates a print job into an enhanced bitmap data which is suitable for printing on the particular printer. Although other installation processes exist, a printer is generally considered installed and can be printed to directly when both the above steps are performed.

An example of a network in which a printer is required to be installed for use is one which uses Novell Netware (a trademarked network operating system from Novell Inc., Orem, Utah, U.S.A.) as the network operating system. Similarly for all computers on the network to be able to print to the specific printer, the same printer will have to be individually installed on every single computer on the network.

A single printer installation may take up to a minute for an experienced administrator. Installing such a printer on a network consisting of many computers can take a proportionally longer time. This installation process is both tedious and time consuming. If the printer is not installed on all computers but only on a few selected computers on the network, the benefit of having an additional printer on the network is not fully capitalized. There are several reasons for not installing a printer on a computer. One reason could be that the users on the computer do not know how to install the printer. Another reason could be the users might not know of the existence of the printer on the network. In the case where a printer is installed on only a few selected computers, only users working on the few selected computers will be able to print to the additional printer. This limitation invariably lowers the printing capacity of the network.

Without the ability to print to all printers on a network, a user of a computer is limited to printing to only printers which are installed on the computer. Even though there are less heavily loaded printers on the network, the user will not be able to print using these printers. The user will have to wait longer for a selected accessible printer to service print jobs which are submitted ahead of the user's before the printer is able to service the user's print job. This inflexibility limits the throughput of the user.

The Windows NT operating system (a trademarked network operating system from Microsoft, Redmond, Wash., U.S.A) provides a “port pooling” feature in which the operating system is able to determine a least heavily loaded printer on the network to service a print job. When the operating system receives a print job, it determines the load of each installed printer on the computer to decide which printer has a least load and is therefore able to service the print job at an earliest time. Although this feature ensures that a user gets a printout in a shortest time possible, it suffers from a disadvantage. This feature still requires the task of installing the printers on the computer.

From the above, there is therefore a need for a method for allowing a user to print to a printer which is connected to a network without having to install the printer on each and every computer on the network. Also the method needs to allow the user to redirect a print job to a printer of the user's choice.

### SUMMARY

In accordance with the preferred embodiment of the invention, a method on a workstation is provided for printing on a printer which is connected to the same network as the workstation and which is not necessarily installed on the workstation.

The invention may be implemented as an application which runs on a workstation. The workstation is able to detect a printer connected to the network which is not installed on the workstation. After detecting the printer, the printer is made available for printing on the workstation.

The workstation preferably detects the printer by querying a server for print queue information. From the print queue information, the workstation is able to detect any printer which is not installed on the workstation. A detected printer is preferably made available to a user through a graphical user interface screen. The user is then able to use the detected printer for printing.

One of the ways in which the detected printer is made available on the graphical user interface screen is by allowing a user to move a print job from one print queue to another print queue of the detected printer. The user will first print to a printer which is installed on the workstation. This printing will cause a print job to be queued on a print queue of the installed printer. The user is then able to redirect this print job to the print queue of the detected printer for printing on the detected printer.

The ability to move a print job from one queue to another allows printing to a printer which is not installed. This ability increases the printing capacity of a network and also gives a user the flexibility of printing to any printer connected to the network.

In another aspect of the invention, a method is provided for redirecting a print job from a source to a target print queue. By emulating a queue server, a workstation can access contents of the print job in the source print queue and generate a print job with the same contents in the target print queue.

### BRIEF DESCRIPTION OF DRAWINGS

The invention will be better understood with reference to the drawings, in which:

FIG. 1 is a schematic diagram of a computer network and its components.

FIG. 2 is a flowchart illustrating the sequence of operation and method for a user on a workstation to print to a networked printer which is not installed on the workstation.

FIG. 3 is an illustrative graphical user interface screen for displaying print queue information and for receiving user commands to manipulate print jobs associated with the print queues.

FIG. 4 is an illustrative graphical user interface screen showing the progress of a print job redirection operation and for allowing a user to abort the redirection operation.

### DETAILED DESCRIPTION OF THE PREFERRED EMBODIMENT

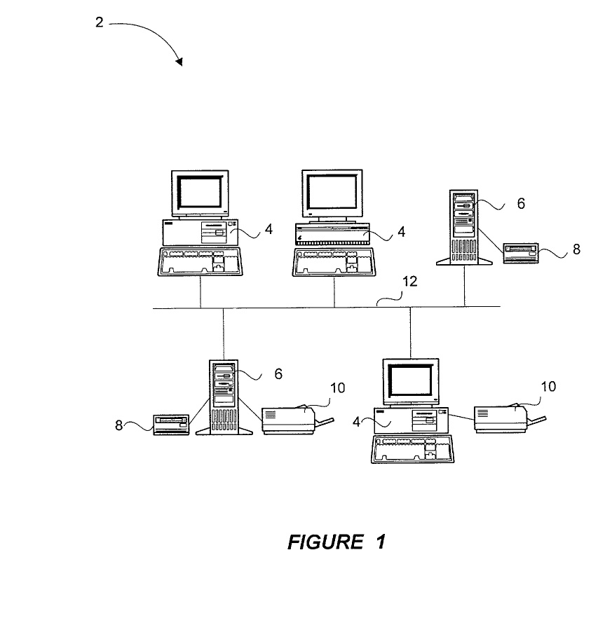

FIG. 1 shows the basic components of a computer network 2. The network 2 is made up of a group of computers 4, 6 that can communicate with each other, share resources, such as hard disks 8 and printers 10, and access remote hosts (not shown) or other networks (not shown). The basic hardware components of a network are one or more servers 6, workstations 4, peripheral devices such as printers 10, network boards (not shown) and a communication medium 12. Each workstation 4 and server 6 require a network board. The network boards connect the servers 6 to the workstations 4 through the communications medium 12. An example of a communication medium is a coaxial cable. The peripheral devices 8, 10 can be attached to the servers 6, workstations 4, or a dedicated device (not shown) acting as a print server. The workstations 4 are only shown in FIG. 1 to be IBM-compatible PCs and Macintoshes. In the context of this specification, a workstation can be any computing device such as a laptop computer and a notebook computer.

A network operating system (OS) such as Novell Netware is used to connect, manage and maintain the network 2 and services which the network 2 provides. This Netware OS enables the workstations 4 to communicate and allow resources 8, 10 to be shared. The Netware OS is implemented as a suite of software components. Some components run only on the server 6 and some run on the workstations 4. A workstation which runs the appropriate Netware components is known as a client.

For the purpose of printer sharing, the server 6 acts as a controller for all the printers 10 on the network 2. Print jobs which are sent from the workstations 4 are received by the server 6 for forwarding to appropriate printers 10. The server 6 maintains the print jobs in the respective printer 10 on the network 2. A software-implemented queue server in the server 6 is responsible for managing the print queues. At an appropriate time, the queue server will send a print job queued on a print queue to a respective printer. A print server acts as an intermediary between the queue server and the printer. This print server will receive the print job for printing on the printer. This print server resides on a device which hosts the printer. As mentioned earlier, this host device may be a server, a workstation or a dedicated device.

The preferred embodiment is described by way of example using a network which runs the Novell Netware network operating system. However the invention is not limited to a network using Novell Netware. The invention can be used in networks running other network operating systems.

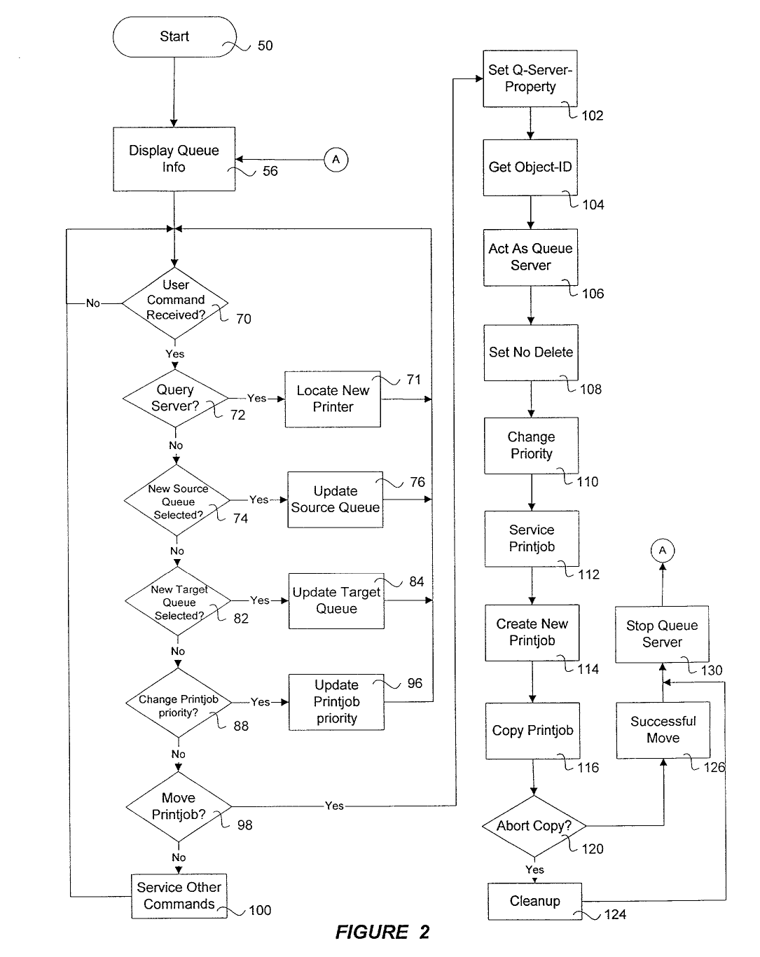

In describing the preferred embodiment, only application programming interface (API) calls relevant to Novell Netware will be used. For more detailed information regarding the APIs, one can refer to the relevant Novell Netware programming manual. The sequence and method of printing to a printer which is not necessarily installed on a workstation is now described with the aid of FIG. 2.

The sequence is described to handle only a single type of printer, namely the HP 2500C. The invention, however, can be used in an environment of heterogeneous printers.

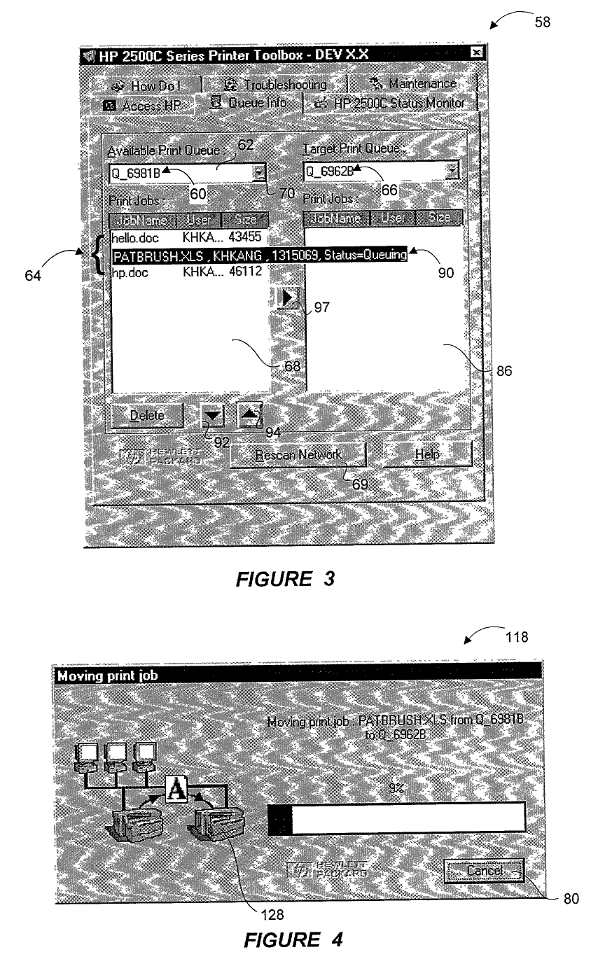

The sequence and method of operation as implemented in an application program running on the workstation is now described in detail. The sequence starts in a START step 50 and proceeds to a DISPLAY QUEUE INFO step 56. FIG. 3 is an illustrative queue display graphical user interface (GUI) screen 58 for the displaying of print queue information. The GUI screen 58 also includes buttons 69, 70, 92, 94, 97 which when activated by a user causes appropriate commands to be sent to the application. In the step 56, the application presents the queue display GUI screen 58 on a display of the workstation. The application shows a source print queue 60 in an available print queue field 62 entitled “Available Print Queue”. The application also displays active print jobs 64 which are queued on the source print queue 60. Similarly, the application displays a target print queue 66 in a target print queue field 63 entitled “Target Print Queue” and any active print jobs (none in this case) which are queued on the target print queue 66. Information such as a print job name, user who sent the print job and the size of the print job are displayed in the source print job field 68. The source and target print queues 60, 66 are selected from a database containing names of printers which are installed on the workstation.

After the application displays the queue display GUI screen 58, the sequence proceeds to a USER COMMAND RECEIVED? step 70. In this step 70, the application allows the user to activate several commands by clicking on the buttons 69, 70, 92, 94, 97. These commands and their corresponding results are described in the flowchart as steps subsequent to the USER COMMAND RECEIVED? step 70. If no command is entered, the application waits in this step 70 for a command from the user. If the user enters a command, the sequence proceeds to a next step to check which of several commands has been entered so that the appropriate actions may be taken.

The sequence proceeds to a QUERY SERVER? step 72 to start the check. In this step 72, the application checks if the user has activated a query server command to query a server for any new printer connected to the network. If the query server command has been activated, the sequence proceeds to a LOCATE NEW PRINTER step 71, where the application queries the server 6 for printers which are connected to the network. The server 6 responds by informing the application of the printers connected to the network. From these printers reported by the server 6, the application is able to identify printers which are connected to the network but not installed on the workstation. The application updates the database with names of these printers. The query server command is activated once when the application is first run or each time the scan network button 69 is activated. The sequence returns to the USER COMMAND RECEIVED step 70 after servicing the query network command.

In a NEW SOURCE QUEUE SELECTED? step 74, the application checks if a new source print queue has been selected. In this preferred embodiment, a user selects a new source print queue by activating an button 70 associated with the source print queue field 62 and selecting a printer from a list of displayed printers. If a new source print queue has been selected, the sequence proceeds to an UPDATE SOURCE QUEUE step 76, where the application queries the server 6 for information of active print jobs on the newly selected source queue. The application displays these active print jobs in the source print jobs field 68. After the UPDATE SOURCE QUEUE step 76, the sequence returns to the USER COMMAND RECEIVED? step 70.

In a NEW TARGET QUEUE SELECTED? step 82, the application checks if a new target print queue has been selected. If a new target print queue has been selected, the sequence proceeds to an UPDATE TARGET QUEUE step 84, where the application queries the server for information of active print jobs on the newly selected target print queue. The application displays the information of these active print jobs in the target print jobs field 86. The sequence subsequently returns to the USER COMMAND RECEIVED? step 70.

In a CHANGE PRINTJOB PRIORITY? step 88, where the application checks if the priority of a currently selected print job 90 in the source print queue is to be changed. The user changes the priority of the print job 90 by activating the appropriate change priority buttons 92, 94. If the user changes the priority of the print job, the sequence proceeds to an UPDATE PRINTJOB PRIORITY step 96, where the application moves the print job 90 forwards or backwards in the print queue 60. The sequence subsequently returns to the USER COMMAND RECEIVED? step 70.

In a MOVE PRINTJOB? step 98, the application checks if the user has chosen to move the selected print job 90 to the target queue 66. The user selects the move command by activating a move button 97 in the GUI screen 58. If the user has not selected to move the print job 90, the sequence proceeds to a SERVICE OTHER COMMANDS step 100. In this step 100, the application services other user commands which are not relevant to this invention and are therefore not described.

If the user has selected to move the print job 90 as determined in the MOVE PRINTJOB? step 98, the sequence proceeds to a SET Q-SERVER-PROPERTY step 102, where the application sets a Q-server-property for the user if it is not already set. The setting of the Q-server-property for the user is necessary in Novell Netware for the application to register itself as a potential candidate to act as a queue server for any print queue. Setting the Q-server-property allows the application to subsequently act as an additional queue server in managing a print queue. To set the Q-server-property, an administrator must give the user the appropriate access permissions.

The application checks whether the Q-server-property is set by calling the NWIsObjectInSet API. If the Q-server-property is not set for the user, the application sets the Q-server-property by calling the NWAddObjectToSet. The sequence next proceeds to a GET OBJECT ID step 104, where the application calls the NWScanObject API to request for object-ids for the source and target print queues 60, 66. The application requests the object-ids by supplying the names of the print queues 60, 66 to the server in the NWScanObject API. The object-ids uniquely identify the print queues 60, 66 in all further communications between the application and the server.

The sequence next proceeds to an ACT AS QUEUE SERVER step 106, where the application calls the NWAttachQueueServerToQueue API to enable the application to act as an additional queue server for the source print queue 60. The sequence next proceeds to a SET NO DELETE step 108, where the application calls the NWChangeQueueJobEntry2 API to instruct the server 6 not to delete a print job until instructed otherwise. This mode of operation is important to allow the possibility of an operation on a print queue to be terminated before its completion. If an operation is terminated before completion, this mode allows the original print job to be easily restored to its earlier original state before the operation was started.

The sequence next proceeds to a CHANGE PRIORITY step 110, where the application moves the selected print job 90 to the head of the source print queue 60, where it will be serviced next ahead of other print jobs in the queue 60. This step 110 is required as Novell Netware adopts a first-in-first-out (FIFO) approach in serving print jobs in a queue. It is therefore necessary to move the print job 90 to the head of the queue in order for the server 6 to service the print job 90. The application moves the print job to the head of the queue 60 by calling the NWChangeQueueJobPosition2 API call.

The sequence next proceeds to a SERVICE PRINTJOB step 112, where the application calls the NWServiceQueueJob2 API to request a source file handle. This source file handle uniquely identifies a file which holds the print job 90 in the source print queue 60.

The sequence proceeds next to a CREATE NEW PRINTJOB step 114, where the application creates a new print job (not shown) in the target print queue 66 through the NWCreateQueueFile2 API call. This will return a target file handle to a file that holds contents of the newly created print job in the target print queue 66.

The sequence proceeds to a COPY PRINTJOB step 116, where the application copies contents of the print job file identified by the source file handle to the newly created print job file identified by the target file handle. This process takes some time to complete depending on the size of the print job 90. FIG. 4 is an illustrative GUI screen 118 which is displayed during the copying process.

The sequence proceeds to an ABORT COPY? step 120, where the application detects any user attempt to abort the move print job operation. The user can cancel the operation by activating a cancel button 122 in the GUI screen 118. If the application detects an abort command from the user, the sequence proceeds to a CLEANUP step 124, where the application terminates the copying of print job content and cleans up both the source and target print queues 60, 66. For the source print queue 60, the application calls the NWAbortServicingQueueJob2 API to abort the servicing of the print job 90 and the NWChangeQueueJobEntry2 API to restore the original properties of the print job 90 prior to the move print job command. This latter API will return the print job to its original position on the source print queue 60. The application also calls the NWCloseFileAndAbortQueueJob2 API to purge the print job from the target print queue 66.

If the user does not interrupt the copying process but allows the copying process to complete, the sequence will proceed to the SUCCESSFUL MOVE step 126, where the application calls NWFinishServicingQueueJob2 API to remove the print job 90 from the source print queue 60. The application will also call NWCloseFileAndStartQueueJob2 to close the new print job (not shown) and allow it to be serviced by the target printer 128.

Regardless of whether the move operation is aborted or not, the sequence proceeds to a DETACH QUEUE SERVER step 130, where the application calls the NWDetachQueueServerFromQueue to stop the application from further acting as an additional queue server for the source print queue 60. The sequence finally returns to the DISPLAY QUEUE INFO 56, where the application updates the GUI screen 58. This updating of the GUI screen completes the redirection of a print job to a print queue of a target printer.

While the present invention has been shown and described with reference to the foregoing operational principles and preferred embodiment, it will be apparent to those skilled in the art that other changes in form and detail may be made.

As an example, the sequence is described to be implemented as an independent application on a workstation but this should not be construed as a limitation. Someone skilled in the art of software programming will know that the sequence may be implemented as a feature in any existing application or driver software.

As a further example, since the application is able to query the server for print job information of all print queues, it will be routinely simple for someone skilled in the art to add an additional load-balancing feature to the application. This feature enables the application to determine a least heavily loaded printer to redirect a print job to.

As a further example, printing of a print job as described in the preferred embodiment requires that the print job be sent to a printer installed on the workstation first before being moved to a target printer. The application can be enhanced to automatically install any newly detected printer in the QUERY SERVER step 72 on the workstation. This allows a user to send any subsequent print job to any of the newly detected printer directly.

The preferred embodiment is also described to detect only HP 2500C type of printers. This restriction is necessary in the preferred embodiment because the HP 2500C printer driver software generates print data which is most suitable for printing on the HP 2500C printer. This print data if printed on another type of printer may result in a printout of less desirable quality. If a printer-independent language, such as the PostScript language, is used to define the print job, the invention can potentially be used with PostScript printers of different types and makes.

The server is also described to be a separate computer from the workstation. This implementation should not be construed as a limitation. Someone skilled in the art would know that a single computer is able to carry out multiple tasks simultaneously. With such a computer, both the workstation and the server may be the same computer.

I claim:

1. A method on a networked workstation for printing on a printer which is connected to the same network as the workstation and which is not installed on the workstation, the method comprising the steps of:
detecting the printer; and
availing the detected printer on the workstation for printing without having to install the printer on the workstation.

2. A printing method according to claim 1, wherein the detecting step comprises using services provided by a server on the network to detect the printer.

3. A printing method according to claim 2, wherein the detecting step comprises:
querying the server for print queue information of printers connected to the network; and
identifying a printer, which is not installed on the workstation from the print queue information, as the detected printer.

4. A printing method according to claim 3, wherein the availing step comprises availing a target print queue associated with the detected printer for receiving a print job.

5. A printing method according to claim 4 further comprising a step of granting appropriate permissions to a user operating the workstation to redirect the print job which is queued on a source print queue to the target print queue.

6. A printing method according to claim 5, wherein the redirecting of the print job comprises the steps of:
creating a new print job on the target print queue;
copying contents of the print job on the source print queue to the new print job on the target print queue; and
removing the print job on the source print queue.

7. A printing method according to claim 6, wherein the redirecting of the print job step further comprises moving the print job to the head of the source print queue prior to the copying step.

8. A printing method according to claim 7, wherein the network employs Novell Netware as a network operating system with the server running a server software and the workstation running a client software which communicates with the server software to enable communication between the workstation and the server.

9. A printing method according to claim 3, further comprising a step of installing the detected printer on the workstation so that the workstation can print directly to the detected printer.

10. A printing method according to claim 9, wherein the step of installing the printer comprises executing an appropriate installation software on the workstation to register the detected printer to the workstation.

11. A printing method according to claim 1, wherein the detecting step comprises detecting a printer of substantially the same printer type as a previously installed printer on the workstation.

12. A printing method according to claim 1, further comprising the steps of:
detecting other printers;
availing the other detected printers for printing without having to install the other detected printers; and
identifying a least loaded printer for printing.

13. A printing method according to claim 12, wherein the detecting of printer steps comprise detecting printers of substantially the same printer type.

14. A printing method according to claim 12, wherein the least loaded printer is a printer which is processing a least amount of print data.

15. A workstation which can be connected to a network, the workstation comprising:
means for detecting a printer which is connected to the network and which is not installed on the workstation; and
means for availing the detected printer on the workstation for printing without having to install the printer on the workstation.

16. A program storage device readable by a workstation, tangibly embodying a program of instructions, executable by the workstation to perform the method steps for printing on a printer which is connected to the same network as the workstation and which is not installed on the workstation, the method steps comprising:
detecting the printer; and
availing the detected printer on the workstation for printing without having to install the printer on the workstation.

17. A method on a workstation for redirecting a print job on a source print queue associated with a source printer to a target print queue associated with a target printer, wherein the workstation and the printers are connected in a network in which a first queue server manages the source and target print queues, the method comprising the steps of:
the workstation acting as a second queue server to access contents of the print job managed by the first queue server; and
the workstation creating another print job on the target print queue which has substantially the same contents as the print job on the source print queue.

18. A print job redirecting method according to claim 17, further comprising a step of granting a user who is operating the workstation appropriate permissions to operate the workstation like a queue server.

19. A print job redirecting method according to claim 18, wherein the step of accessing contents of the print job comprises the steps of:
the workstation moving the print job to the head of the source print queue as a queue server; and
obtaining a file handle to a file which contains the contents of the print job.

20. A print job redirecting method according to claim 19, wherein the step of creating another print job on the target print queue comprises the steps of:
the workstation creating a new print job on the target print queue;
copying the contents of the print job on the source print queue to the new print job on the target print queue; and
removing the print job on the source print queue.
